(19) United States
(12) Patent Application Publication
(10) Pub. No.: US 2026/0064078 A1
(43) Pub. Date: Mar. 5, 2026

(54) RESONANT ORGAN FOR A STRIKING MECHANISM OF A TIMEPIECE, THE STRIKING MECHANISM COMPRISING SUCH A RESONANT ORGAN, AND METHOD FOR MANUFACTURING SUCH A RESONANT ORGAN

(71) Applicant: OMEGA SA, Biel/Bienne (CH)

(72) Inventors: Gregory KISSLING, La Neuveville (CH); Damien CLEMENCON, Orvin (CH); Olivier SILVANT, Macolin (CH); Kilian MOSIMANN, Zollikofen (CH)

(73) Assignee: OMEGA SA, Biel/Bienne (CH)

(21) Appl. No.: 19/304,984

(22) Filed: Aug. 20, 2025

(30) Foreign Application Priority Data
Sep. 5, 2024 (EP) 24198690.0

(51) Int. Cl. G04B 21/08; G04D 3/02; G04D 3/04

(52) U.S. Cl. CPC G04B 21/08; G04D 3/0227; G04D 3/04

(57) ABSTRACT

A resonant organ (100) for a striking mechanism (200) including a gong (110a, 110b) attached to a gong holder (120), wherein the gong (110a, 110b) has a notch (117) in which a stone (1) is embedded and secured, the stone (1) including a table (3) with an impact surface suitable for being struck by a hammer (210a, 210b) of the striking mechanism (200).

### CROSS REFERENCE TO RELATED APPLICATIONS

This application claims priority to European Patent Application No. 24198690.0 filed Sep. 5, 2024, the entire contents of which are incorporated herein by reference.

### TECHNICAL FIELD OF THE INVENTION

The invention relates to a resonant organ comprising at least one gong for a striking mechanism of a timepiece.

The invention also relates to a striking mechanism comprising such a resonant organ and to a horology movement comprising a striking mechanism.

The invention also relates to a timepiece comprising a horology movement fitted with a striking mechanism, and to a method for manufacturing a resonant organ for the striking mechanism of a timepiece.

### TECHNOLOGICAL BACKGROUND

In the field of horology, a horology movement can comprise a striking mechanism. This can be achieved by providing at least one gong, which is a metal wire that is usually circular in shape, for example made of steel.

This wire is usually arranged around the movement in the watchcase in a plane parallel to the dial. This gong is attached, for example by soldering or brazing, to a gong holder, which is itself attached to the plate or middle of the watchcase. The gong can also be made in one piece with the gong holder as a single unit.

The vibration of the gong is produced by the impact of at least one hammer, which is usually near the gong holder. This vibration is made up of several natural frequencies and of partials, the number and intensity of which, particularly in the audible range between 1 kHz and 20 kHz, depend on the geometry of the gong and the physical properties of the material used.

To tune gongs, the length of each gong usually has to be adjusted or a recess also has to be cut into the setting to change the pitch of the sound. This usually has the effect of shifting the frequencies of all the modes. The frequency of a mode can be set to a target frequency, but the other partials will usually be resultant and uncontrolled.

Other work has been carried out on the gong material to change the sound generated, influence the partials or improve the amplitude of sound and thereby the sound perception outside the timepiece.

In recent years, efforts have been made to enable the production of gongs that generate a well-defined sound, particularly in terms of their pitch and their frequency composition, either through the choice of gong material or through the choice of gong geometry.

In particular, patent EP 2 107 436 B1 provides for the use of a gold gong to increase the partials in the sound vibration generated by the hammer strike. The creation of a gold gong adds considerable richness to the sound generated when a hammer strikes the striking mechanism. However, if several gold gongs are used in the striking mechanism to generate different notes, there can still be problems with dissonance when the gongs are tuned or in the succession of sounds from gongs successively struck by a hammer, which is a drawback.

Patent application CH 707078 A1 describes the addition of a different material to an opening in a gong to change the sound generated. To do so, each gong is configured to generate a specific sound with a specific pitch and frequency composition. For example, to adjust a frequency deviation or control its vibratory behaviour, the gong can comprise at least one opening in the main body that is filled with a material other than the basic material of the gong.

However, making openings in each gong to be filled with another material makes setting the vibration frequency more complicated, which is a drawback.

The solutions currently known in the prior art are either complex to achieve, which prevents the gongs from being produced properly, or they do not enable gongs to be produced with all the desirable characteristics in terms of the quality of the sound produced.

Consequently, there is a need to improve the resonant organs for timepiece striking mechanisms.

### SUMMARY OF THE INVENTION

The invention therefore aims to remedy at least one of the drawbacks of the prior art described above by providing a resonant organ for the striking mechanism of a timepiece, capable of producing audible vibrations with a more intense and harmonious sound, with no dissonance, and with a greater resonance over time for at least certain frequency modes.

To this end, the invention relates to a resonant organ for a striking mechanism comprising a gong attached to a gong holder, characterised in that said gong comprises a notch in which a stone is embedded and secured, said stone comprising a table with an impact surface suitable for being struck by a hammer of the striking mechanism.

The resonant organ provided with a stone at the point of impact according to the invention makes it possible to achieve a more intense and resonant sound, which improves perception and the perceived quality of a striking mechanism fitted with such a resonant organ.

In addition to the characteristics mentioned in the previous paragraph, the resonant organ according to the invention can have one or more complementary characteristics from among the following, taken individually or in any technically possible combination:
said stone has a hardness greater than 7 Mohs;
said stone is a precious, semi-precious or synthetic stone;
said stone is a diamond, a ruby, or a sapphire;
said stone is secured in the notch by a closed setting, a grain setting or a baguette setting;
said stone is glued or driven into the notch;
said stone is ultrasonically driven into the notch;
said stone has a bell cap, a girdle, said bell cap being at least partially embedded in the notch;
the table has a flat impact surface or a curved impact surface;
said gong is at least partially circular in shape; for example, the gong has a diameter corresponding to the diameter of a watch glass, while forming a portion of a circle at an angle that can be between 150° and 360°;
said gong has a circular or rectangular cross-section;
said gong is a first gong and in that said resonant organ comprises a second gong;
said second gong is attached to said gong holder.

The invention also relates to a striking mechanism comprising a resonant organ according to the invention and a hammer comprising a striker configured to strike the impact surface of the stone table.

Preferentially, the striker is made of carbon steel or tungsten carbide.

The invention also relates to a horology mechanism comprising a striking mechanism according to the invention.

The invention also relates to a timepiece, for example a wristwatch, comprising a horology movement according to the invention.

The invention also relates to a method for manufacturing a resonant organ according to the invention. The manufacturing method comprises:
a step in which a resonant organ comprising a gong attached to a gong holder is supplied;
a step in which a notch is machined in the material of the gong;
a step in which a stone is positioned in said notch;
a step in which said stone is secured in the notch on the gong.

Preferentially, in the machining step, the notch is machined by milling.

Preferentially, the step in which said stone is secured is carried out by setting the stone in the notch, for example using a closed setting or a grain setting.

### BRIEF DESCRIPTION OF THE FIGURES

The purposes, advantages and characteristics of the present invention will become apparent from the detailed description below in reference to the following figures:

FIG. 1 is a schematic top view of an exemplary embodiment of a resonant organ according to the invention for a striking mechanism of a horology movement;

FIG. 2 is a perspective view of the resonant organ according to the invention as illustrated in FIG. 1;

FIG. 3 is a close-up view of a portion of the resonant organ illustrated in FIG. 1, showing more specifically the inlay of a stone in the material of the resonant organ;

FIG. 4 is a cross-sectional view along the axis A-A illustrated in FIG. 3, showing the cross-section of the resonant organ where the stone is inlaid;

FIG. 5 is a partial schematic top view of an exemplary embodiment of a striking mechanism according to the invention comprising the resonant organ as illustrated in FIGS. 1 to 3;

FIG. 6 is a perspective view of the striking mechanism according to the invention as illustrated in FIG. 5;

FIG. 7 is a close-up view of FIG. 6, illustrating more specifically the impact zone of the resonant organ struck by a hammer of the striking mechanism;

FIG. 8 is a schematic view of a timepiece incorporating a horology movement comprising a striking mechanism according to the invention;

FIG. 9 is a flow chart illustrating the main steps in a method for manufacturing a resonant organ according to the invention;

FIG. 10 is a spectrogram of a sound generated by the percussion of a gong from the prior art with no stones in the impact zone;

By way of comparison, FIG. 11 is a spectrogram of the sound generated by the percussion of a gong according to the invention comprising a stone in the impact zone.

In all of the figures, common elements have the same reference numbers unless otherwise specified.

### DETAILED DESCRIPTION OF THE INVENTION

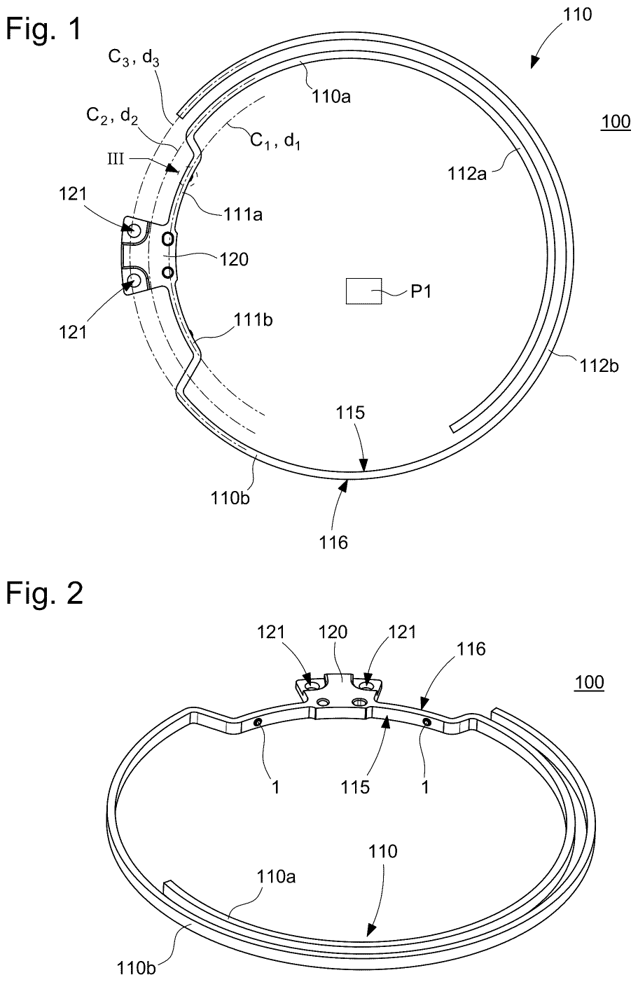

FIG. 1 is a schematic top view of an exemplary embodiment of a resonant organ 100 according to the invention for the striking mechanism 200 of a horology movement 300.

FIG. 2 is a perspective view of the resonant organ 100 according to the invention as illustrated in FIG. 1.

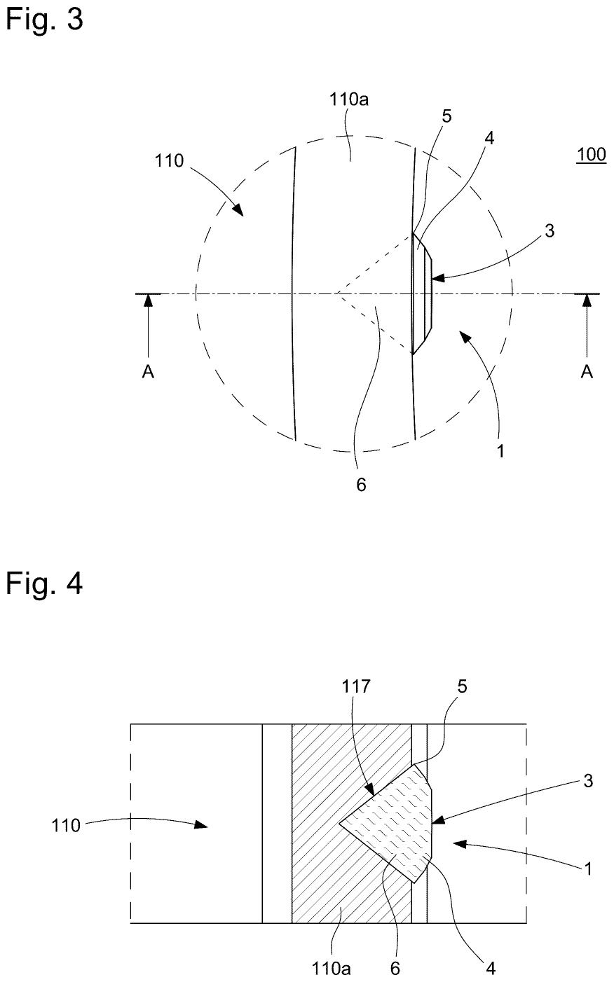

FIG. 3 more specifically shows a close-up view of the resonant organ 100 where a stone 1 is inlaid in the material of the resonant organ 100, located in the impact zone of the resonant organ 100 struck by a hammer of a striking mechanism.

FIG. 4 is a cross-sectional view along the axis A-A of the resonant organ 100 illustrated in FIG. 3 showing the cross-section of the resonant organ 100 where the stone 1 is inlaid.

With reference to FIGS. 1 to 4, the resonant organ 100 according to the invention has a resonant part 110 formed by one or more gongs 110a, 110b and an attachment part 120, referred to as a gong holder, in the continuation of at least one end of the gongs 110a, 110b of the resonant organ 100.

The second end of the gongs 110a, 110b is usually free so that the gongs 110a, 110b can vibrate more easily. However, the gongs 110a, 110b can be attached to the attachment part 120 at both ends.

The resonant organ 100 can comprise a plurality of gongs 110a, 110b which can be connected to one or more gong holders 120. Each gong of the resonant organ 100 can also have a dedicated gong holder 120.

In the exemplary embodiment shown in the figures, the resonant organ 100 comprises two gongs 110a, 110b, each of the gongs 110a, 110b being connected at one end to the same gong holder 120.

For example, the attachment part 120 and the resonant part 110 of the resonant organ 100 form a single piece, meaning that both parts are made in one piece from the same material.

However, the attachment part 120 and the resonant part 110 of the resonant organ 100 can also be made separately and then joined together by a joining method known to the person skilled in the art, for example by brazing or soldering. This makes it possible to combine gongs made of different materials on the same gong holder. This approach is particularly advantageous when the resonant organ 100 comprises several gongs for generating a melody with different tones. In this way, the nature of the gong material can be used to change the sound of the gong.

Each gong 110a, 110b is in the form of a wire or blade with a predetermined length, width and thickness according to the desired sound. The dimensions of each gong 110a, 110b are determined according to the constraints and to the desired sound.

Each gong 110a, 110b is configured and shaped to generate a harmonious sound with no dissonance. Preferentially, each gong 110a, 110b is configured to generate a different sound from the other gongs 110b, 110a making up the resonant organ 110.

The two gongs 110a, 110b have, in a plane parallel to the plane referenced P1 in FIG. 1 which is a reference plane of the horology movement 300, an overall curvilinear shape, for example circular; however, other shapes are also possible without departing from the scope of the invention. The two gongs 110a, 110b can be in different planes.

Preferentially, the diameter of the circle formed by the gongs 110a, 110b substantially corresponds to the diameter of the glass on the timepiece 10. The gongs 110a, 110b form an arc extending over a circular sector comprised between 150° and 360°, preferably between 185° and 220°. Each gong is designed to surround at least part of the horology movement 300.

As shown in the figures, each gong 110a, 110b can extend along one or more circles defined in the same plane, parallel to plane P1, and which have different diameters.

As shown in FIG. 1, each gong 110a, 110b comprises a first proximal portion 111a, 111b of the gong holder 120 that extends along a first circle C₁ with a diameter d₁ and a second distal portion 112a, 112b of the gong holder 120 that extends along a second circle C₂ with a diameter d₂ or along a third circle C₃ with a diameter d₃, the diameter d₁ of circle C₁ being less than the diameter d₂, d₃ of the second and third circles C₂, C₃. Preferentially, circles C₁, C₂, C₃ are concentric.

The gongs 110a, 110b can have a curvilinear cross-section, for example circular, or a polygonal cross-section, for example parallelepipedal, preferentially rectangular.

The gongs 110a, 110b can also have a section with sectors of different shapes and/or dimensions.

In the exemplary embodiment shown, the gongs 110a, 110b are in the form of a blade with a rectangular cross-section. To this end, the gong 110a, 110b comprises a radially inner vertical face 115, relative to the centre of the gong 110a, 110b, and a radially outer vertical face 116, the two vertical faces being oriented perpendicularly to the plane P1.

The gong holder 120 is shown in the form of a plate, but other forms of gong holder can be considered. The thickness of the gong holder 120 is preferentially about the same as the thickness of the gongs 110a, 110b.

The gong holder 120 comprises openings 121 for attaching, for example with screws, the resonant organ 100 to a plate (not shown) on which the horology movement 300 rests. According to a variant embodiment, the gong holder 120 can also be attached to an edge or wall of the middle of a case 11 of a timepiece 10, such as a watch.

The resonant organ 100 is part of a striking mechanism 200 that preferably comprises at least one hammer 210a, 210b per gong 110a, 110b, configured and shaped to strike the gong 110a, 110b at predetermined times on a precise zone of the gong 110a, 110b.

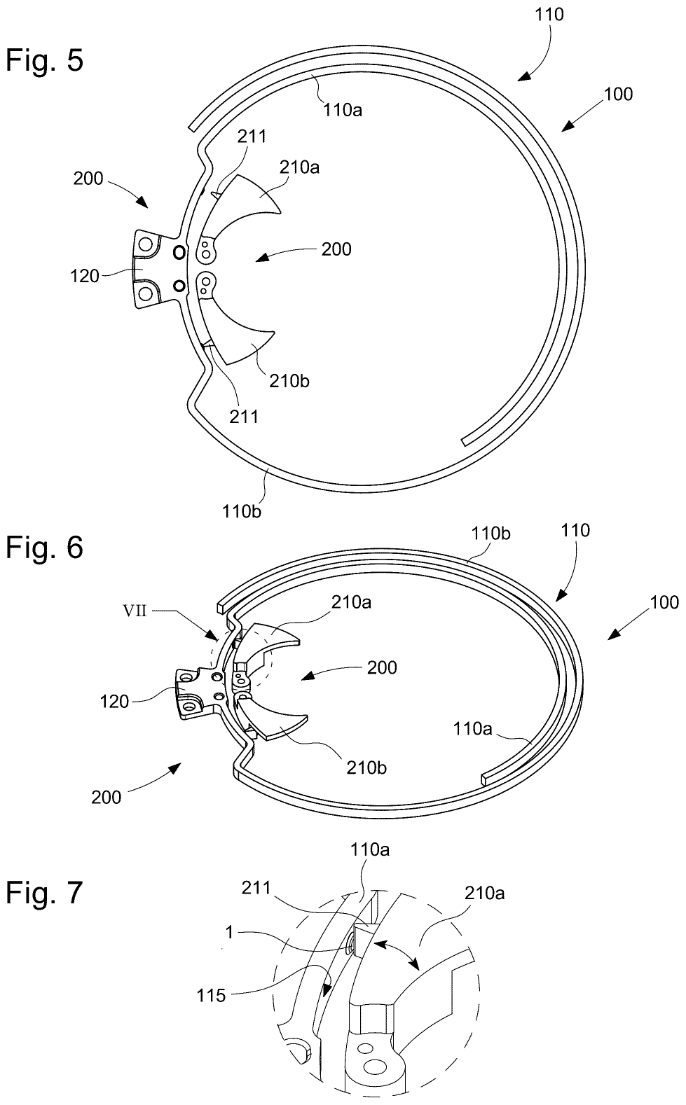

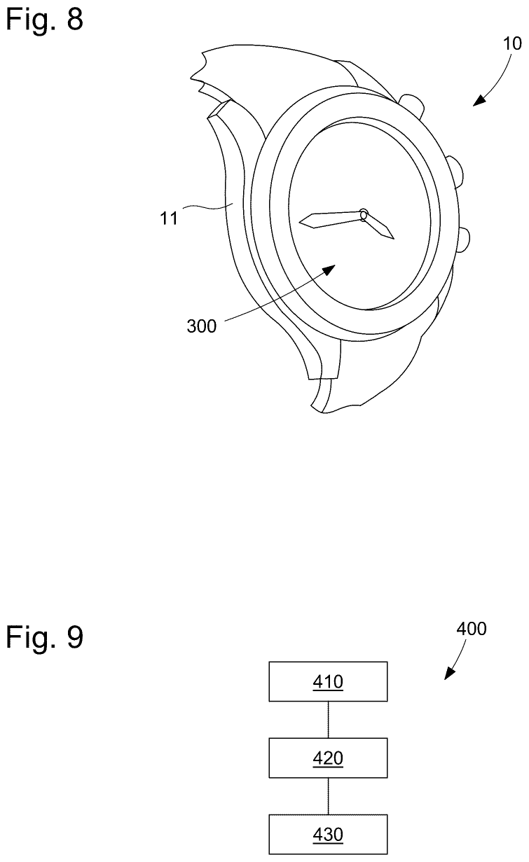

The hammers 210a, 210b of the striking mechanism 200 are shown more specifically in FIGS. 5, 6 and 7.

FIG. 5 is a partial schematic top view of an exemplary embodiment of a striking mechanism 200 according to the invention comprising the resonant organ 100 described above.

FIG. 6 is a perspective view of the striking mechanism 200 according to the invention as illustrated in FIG. 5.

FIG. 7 is a close-up view of FIG. 6, illustrating more specifically the portion of the resonant organ 100 struck by a hammer 210a of the striking mechanism 200.

Together with the gongs 110a, 110b of the resonant organ 100, the striking mechanism 200 comprises two hammers 210a, 210b.

Each hammer 210a, 210b comprises a striker 211 designed to strike the gong 110a, 110b and generate sound and vibration from the gong 110a, 110b on impact. This vibration is made up of several natural frequencies or partials, the number and intensity of which, particularly in the audible range between 1 kHz and 20 kHz, depend on the geometry of the gong and the physical properties of the material used.

Preferentially, the striker 211 is made from a hardened steel and has a hardness greater than 600 HV, preferentially greater than 1,600 HV.

For example, the striker 211 is made of carbon steel or tungsten carbide.

The hammers 210a, 210b are rotatably mounted on the plate and are configured to strike each corresponding gong 110a, 110b at predetermined times to generate a sound and a melody.

The hammers 210a, 210b are conventionally set in motion by the horology movement 300 by means of a dedicated energy source or one shared by the time train of the horology movement 300.

According to the invention, each gong 110a, 110b has a stone 1 positioned facing the striker 211 of the hammer 210a, 210b so as to be struck by it.

Preferentially, the stone 1 is positioned in the proximal portion 111a, 111b of the gong 110a, 110b, near the gong holder 120.

With reference to FIG. 3, the stone 1 is, for example, a cut stone with a table 3, a crown 4, a girdle 5 and a bell cap 6. Table 3 forms the impact surface that receives the striker 211 of hammer 210a, 210b.

For example, the table 3 is flat as shown in FIG. 3.

The table 3 can also be of any shape; for example, the table 3 can be a curved surface, for instance spherical or cylindrical in shape.

Preferentially, the shape of the table 3 is chosen to minimise the extent of the impact surfaces between the table 3 and the striker 211 of the hammer 210a, 210b.

In the example shown, the stone 1 has a traditional cut stone shape with a conical bell cap 6. However, the stone 1 can have other shapes provided that the table 3 has an impact surface directed towards the striker 211 configured to receive the striker 211 of the hammer 210a, 210b.

According to an alternative embodiment, the stone 1 can have a parallelepipedal shape.

To inlay the stone 1, the gong 110a, 110b has a non-through notch 117 machined in the thickness of the gong 110a, 110b, for example by milling, micromachining or laser ablation, and configured to at least partially receive and embed the bell cap 6 of the stone 1.

The geometry and shape of the notch 117 are adapted to the shape of the bell cap 6 of the stone 1 to be attached.

Preferentially, the geometry and shape of the notch 117 are designed to maximise the contact surfaces at the interface between the bell cap 6 of the stone 1 and the notch 117 on the gong 110a, 110b.

Preferentially, the stone 1 is secured to the gong 110a, 110b by setting. According to an alternative embodiment, the stone 1 can be glued into the notch 117.

Preferentially, the stone 1 is secured to the gong 110a, 110b by a closed setting, a grain setting or a baguette setting.

According to an alternative embodiment, the stone 1 is driven into the notch 117 of the gong 110a, 110b, for example using an ultrasonic driving-in method.

The table 3 of the stone 1 protrudes relative to the surface of the gong 110a, 110b that has the notch 117 so as to form an impact surface for the striker 211 which protrudes relative to the radially inner surface 115 of the gong 110a, 110b.

Preferentially, the stone 1 has a hardness greater than 7 Mohs.

Preferentially, the stone 1 is a precious, semi-precious or synthetic stone, for example a diamond, a ruby or a sapphire.

According to an alternative embodiment, the stone 1 can be a metallic glass stone.

The resonant organ 100, or more specifically the gong 110a, 110b, can be made of amorphous metal or metallic glass.

The resonant organ 100, or more specifically the gong 110a, 110b, can be made of gold, platinum, brass, titanium, aluminium or another metal material or alloy.

The metallic glass can be, for example, zirconium-based, gold-based, platinum-based, gold with palladium, platinum, silver or another metal capable of solidifying in amorphous form.

The invention results in better vibration of the gong and an improvement in the perceived acoustic level. Thus, with the stone 1 providing an impact surface for the striker 211 of the hammer 210a, 210b, the sound generated by the vibration of the gong 110a, 110b has a higher acoustic level, with an increase of at least 1 dB.

The tests were carried out with a diamond stone set using a closed setting, resulting in a gain of 1.8 dB relative to a gong of the same shape and material with no stone.

The use of a stone 1 as the point of impact for the striker 211 enables the low-frequency modes to be accentuated, reinforcing perception through the use of the sound generated by the vibration of the gong.

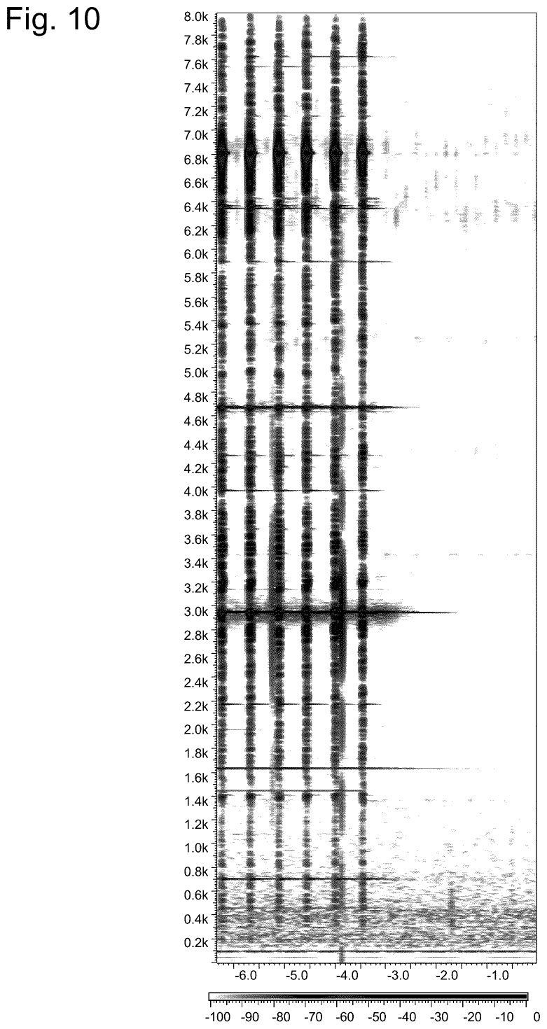

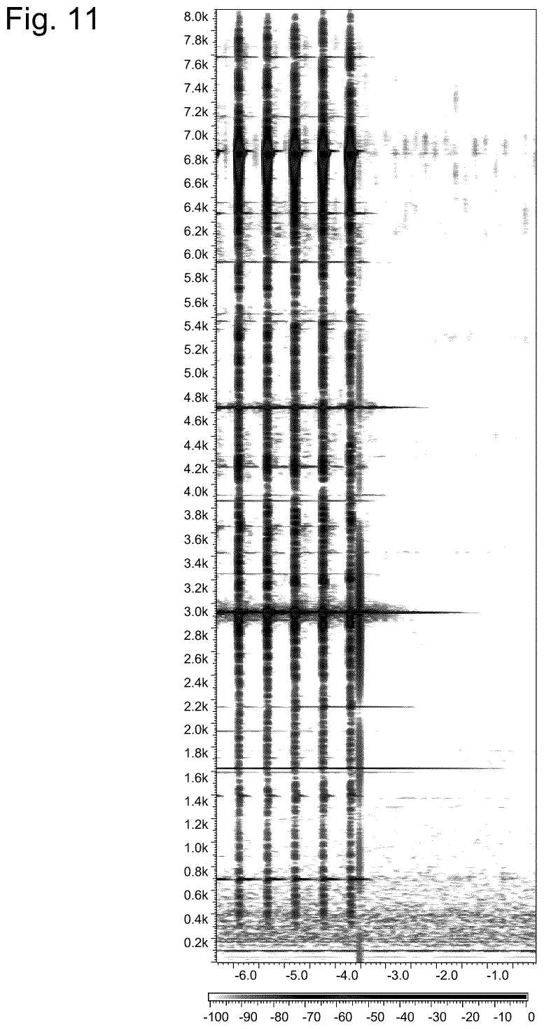

FIGS. 10 and 11 show two spectrograms produced by impacting a gong according to the prior art and a gong according to the invention. The tests were carried out using the same striker and with identical gong material and geometry.

FIG. 10 more specifically shows the spectrogram of the sound vibration of a gong according to the prior art and FIG. 11 shows the spectrogram of the sound vibration of a gong according to the invention comprising a stone at the point of impact of the striker 211.

Spectrograms conventionally illustrate a sound vibration in three dimensions in which the y-axis indicates the different frequencies making up the sound vibration, the x-axis indicates the time, and the intensity shown in black and white indicates the intensity or power of the various modes of the sound vibration.

In particular, it can be seen that in the spectrogram of the gong according to the invention, the low-frequency modes are more pronounced. For example, the resonance of the 1.6 kHz mode is two times that of the prior art and the resonance of the 2.2 kHz mode is three times that of the prior art.

The invention thus makes it possible to increase both the duration and the power of certain modes of sound vibration, resulting in a better perception of the vibration of the gong by the user.

The invention also relates to a method for manufacturing 400 a resonant organ 100 according to the invention. FIG. 9 illustrates the main steps in the manufacturing method 400 using a flow chart.

The manufacturing method 400 comprises a step in which a resonant organ 100 comprising a gong 110a, 110b attached to a gong holder 120 is manufactured. The resonant organ 100 can be produced by moulding, rolling, wire blanking, stamping a sheet of metallic material, milling, laser machining, electrical discharge machining, casting or hot-pressing.

The manufacturing method 400 further comprises, in succession:
a step 410 in which a notch 117 is machined in the material of the gong 110a, 110b; the machining is carried out, for example, by milling, micromachining or laser ablation;
a step 420 in which the stone 1 is positioned in the notch 117, such that the bell cap of the stone 1 is at least partially embedded in the notch 117;
a step 430 in which the stone 1 is secured in the notch 117 in the gong 110a, 110b to keep it in place.

Preferentially, the securing step is carried out by setting the stone 1, for example using a closed setting, a grain setting or a baguette setting.

However, according to an alternative embodiment, the stone 1 can be glued or driven into the notch 117.

For example, the stone 1 is ultrasonically driven into the notch 117.

1. A resonant organ for a striking mechanism comprising a gong attached to a gong holder, wherein said gong comprises a notch in which a stone is embedded and secured, said stone comprising a table with an impact surface suitable for being struck by a hammer of the striking mechanism.

2. The resonant organ for a striking mechanism according to claim 1, wherein said stone has a hardness greater than 7 Mohs.

3. The resonant organ for a striking mechanism according to claim 1, wherein said stone is a precious, semi-precious or synthetic stone.

4. The resonant organ for a striking mechanism according to claim 3, wherein said stone is a diamond, a ruby or a sapphire.

5. The resonant organ for a striking mechanism according to claim 1, wherein said stone is secured in the notch by a closed setting, a grain setting or a baguette setting.

6. The resonant organ for a striking mechanism according to claim 1, wherein said stone is glued or driven into the notch.

7. The resonant organ for a striking mechanism according to claim 6, wherein said stone is ultrasonically driven into the notch.

8. The resonant organ for a striking mechanism according to claim 1, wherein said stone has a bell cap and a girdle, said bell cap being at least partially embedded in the notch.

9. The resonant organ for a striking mechanism according to claim 1, wherein the table has a flat impact surface or a curved impact surface.

10. The resonant organ for a striking mechanism according to claim 1, wherein said gong is at least partially circular in shape.

11. The resonant organ for a striking mechanism according to claim 1, wherein said gong has a circular or rectangular cross-section.

12. The resonant organ for a striking mechanism according to claim 1, wherein said gong is a first gong and in that said resonant organ comprises a second gong.

13. The resonant organ for a striking mechanism according to claim 12, wherein said second gong is attached to said gong holder.

14. A striking mechanism comprising a resonant organ according to claim 1 and a hammer comprising a striker configured to strike the impact surface of the table on the stone.

15. The striking mechanism according to claim 14, wherein the striker is made of carbon steel or tungsten carbide.

16. A horology movement comprising a striking mechanism according to claim 14.

17. A timepiece comprising a horology movement according to claim 16.

18. A method for manufacturing a resonant organ comprising a gong attached to a gong holder, wherein the manufacturing method comprises:
a step in which a notch is machined in the material of the gong;
a step in which a stone is positioned in said notch;
a step in which said stone is secured in the notch on the gong.

19. A method for manufacturing a resonant organ according to claim 18, wherein in the machining step, the notch is machined by milling, micromachining or laser ablation.

20. A method for manufacturing a resonant organ according to claim 18, wherein the step in which said stone is secured is carried out by setting, by gluing or by driving in.
